(19) United States
(12) Patent Application Publication
(10) Pub. No.: US 2004/0235994 A1
(43) Pub. Date: Nov. 25, 2004

(54) Gasket rubber product

(76) Inventors: Masaru Okamoto, Okayama (JP); Takashi Nanba, Okayama (JP)

Correspondence Address: WENDEROTH, LIND & PONACK, L.L.P., 2033 K STREET N. W., SUITE 800, WASHINGTON, DC, 20006-1021, US

(21) Appl. No.: 10/797,151

(22) Filed: Mar. 11, 2004

(30) Foreign Application Priority Data
Mar. 11, 2003 (JP) 2003-064308

(51) Int. Cl. C08K 5/24

(52) U.S. Cl. 524/261

(57) ABSTRACT

A gasket rubber product made of a cured material of a fluorosilicone rubber composition containing:

100 parts by weight of an organopolysiloxane expressed by the following average composition formula:

R²ₐR²_{b}R³, SiO_{(4-a-b-c)/2}

wherein R¹ indicates a trifluoropropyl group, R² indicates a non-substituted or substituted monovalent aliphatic unsaturated hydrocarbon group having 2 to 8 carbon atoms, R³ indicates a non-substituted monovalent aliphatic saturated hydrocarbon group or aromatic hydrocarbon group having 1 to 8 carbon atoms provided that a, b and c are positive numbers satisfying 0 96≦a≦1.01, 0.002≦b≦0.02, 0.96≦c≦1.06 and 1.98≦a+b+c≦2.02;

5 to 10 parts by weight of a silica-based filler; and

a catalyst quantity of a curing catalyst.

### BACKGROUND OF THE INVENTION

1. Field of the Invention

The present invention relates to a gasket rubber product, and particularly, to a gasket rubber product made of fluorosilicone rubber. The compression set of this gasket rubber product made of fluorosilicone rubber is not degraded even under a heating condition over time, especially, in a case of being employed as a resin intake manifold gasket, which is used in contact with a resin such as 6 Nylon.

2. Description of the Related Art

Fluorosilicone rubber is excellent in heat resistance, cold resistance, oil resistance, fuel oil resistance, compression stability and the like, which is described in Japanese Patent Application Laid-Open (JF-A) No. 62-174260, and has been used widely as material of parts or components in equipment used in transports such as an automobile and an airplane, and a petroleum marine transport.

In a case where fluorosilicone rubber is used as a gasket material for a resin intake manifold, which is used, especially, in contact with a resin such as Nylon, fluorosilicone rubber is, in some cases, degraded in compression set over time if it is used under a heating condition in contact with a resin such as 6 Nylon. A value of compression set in this situation is larger than the value of compression set when it is used without contacting to with 6 Nylon. Rubber hardness measured in said situation is reduced as compared with that in a initial state thereof, leading to understanding of occurrence of softening and degradation accompanying disconnection of an Si—O bond in the main chain of a fluorosilicone polymer. Such disconnection of the main chain of a fluorosilicone polymer is thought to be caused by aniline, caprolactam and derivatives thereof, which are generated during heating of Nylon resin

For reduction in the before described degradation, there is available a method to add a filler in an great amount. In this method, however, addition of reinforcing silica such as fumed silica or precipitated silica in great amount problematically results in increase in rubber hardness to a value equal to or higher than a practical upper limit and at the same time, reduce moldability of rubber obtained in terms of physical properties. Addition of non-reinforcing silica such as quartz fine powder or diatomaceous earth results in insufficient mechanical strengths such as tensile strength, tear strength and the like in terms of physical properties.

It is also considered to use an additive in order to capture aniline, caprolactam and derivatives thereof, which are generated when a Nylon resin is heated. An additive that is considered to be useful for achievement of the object of the present invention, however, is acidic or alkaline and conversely accelerates disconnection of an Si—O bond in the main chain of fluorosilicone polymer, which is impractical.

In Japanese Patent Application Laid-Open (JP-A) No 2001-182837, rubber parts for fuel seal made of fluorosilicone rubber covered with Nylon have been proposed. But, the contents of fluorosilicone rubber is not desclosed in JP-A No 2001- 182837.

### SUMMARY OF THE INVENTION

The present invention has been made in light of the above circumstances. An object of the present invention is to provide a gasket rubber product made of fluorosilicone rubber especially useful as a resin intake manifold gasket material, wherein a compression set value of said gasket rubber product is low and a change in he value over time of said gasket rubber product is small, especially, even in a case that said gasket rubber product made of fluorosilicone rubber is contacting with 6 Nylon, a compression set value of said gasket rubber product is low and a change in the value over time of said gasket rubber product is small.

The inventor has been conducted serious studies in order to achieve the above object, and found that a rubber product obtained by cure-molding a fluorosilicone composition containing a silica-based filler and a curing catalyst and an organopolysiloxane expressed by the average composition formula R¹ₐR²_{b}R³_{c}SiO_{(4-a-b-c)/2} is low in compression set value and with a small change in the value over time, especially, even in a case that said rubber product is contacting with 6 Nylon, a compression set value of said rubber product is low and a change in the value over time is small. The present invention was led by this finding.

That is, the present invention is to provide a gasket rubber product made of a cured material of a fluorosilicone rubber composition containing 100 parts by weight of the below described component (A). 5 to 100 parts by weight of the below described component(B), and catalyst quantity of the below described componet (C).

Component(A):

An organopolysiloxane expressed by the average composition formula R¹ₐR²R³_{c}SiO_{(4-a-b-c)/2}.

In this average composition formula, R¹ indicates a trifluoropropyl group, R² indicates a non-substituted or substituted monovalent aliphatic unsaturated hydrocarbon group having 2 to 3 carbon atoms, R³ indicates a non-substituted monovalent eliphatic saturated hydrocarbon group or aromatic hydrocarbon group having 1 to 8 carbon atoms, provided that a, b and c are positive numbers satisfying 0.96≦a≦1.01, 0.002≦b≦0.02, 0.96≦c≦1.06 and 1.98≦a+b+c≦2.02.

Componont(B): A silica-based filler.

Componont(C): A curing catalyst.

The before described gasket rubber product of the present invention can be used in contact with a resin such as 6 Nylon.

The before described gasket rubber product of the present invention is useful as a gasket material for a resin intake manifold. A compression set of the before described gasket rubber product of the present invention is not degraded even under a heating condition over time while being in contact with a resin such as 6 Nylon. So that, the before described gasket rubber product of the present invention is, especially, useful when it is used as a resin intake manifold gasket, which is used in contact with a Nylon resin.

### DESCRIPTION OF THE PREFERRED EMBODIMENTS

Detailed description will be given of the present invention below.

An organopolysiloxane as a component (A) is expressed by the following average composition formula.

R¹ₐR²_{b}R³ SiO_{(4-a-b-c)/2}

In this average composition formula, R¹ indicates a trifluoroprodyl group.

And, R¹ indicates a non-substituted or substituted monovalent aliphatic unsaturated hydrocarbon group having 2 to 8 carbon atoms. Examples of R² include alkenyl groups such as a vinyl group, an allyl group, a propenyl group, a butenyl group, and a hexenyl group and the like. Among the before described examples, a vinyl groups is preferable.

Also, in the before described average composition formula, R³ indicates a non-substituted monovalent aliphatic saturated hydrocarbon group or aromatic hydrocarbon group having 1 to 8 carbon atoms. Examples of R include; alkyl groups such as a methyl group, an ethyl group, a propyl group, a butyl group, a hexyl group and the like; aryl groups such as a phenyl group, a tolyl group and the like; aralkyl groups such as a benzyl group; and the like. Among the before described examples, a methyl group is preferably.

Further, in the before described average composition formula, a, b and c are positive values, satisfying the following conditions that a is in the range of from 0.96 to 1.01, b is in the range of from 0.002 to 0.02, c is in the range of from 0.96 to 1.06 and a+b+c is in the range of from 1.98 to 2.02.

In an organopolysiloxane, described above, if a is less than 0.96, characteristics such as a fuel oil resistance and the like are inefficient, while if exceeding 1.01, production thereof is impractically hard.

It is especially important in the present invention that b is in the range of from 0.002 to 0.02(0.1 to 1% by mole).

R²may be either on the end of main chain or on a side chain, or on both. If b is smaller than 0.002 (0.1% by mole), it is impossible to obtain compression set characteristics, that is a value of compression set is low and a change thereof over time is small. On the other hand, if b is larger than 0.02 (1% by mole), a rubber hardness impractically increases and becomes brittle to reduce mechanical strengths such as a tensile strength, a tear strength and the like, thereby lowering a performance as a gasket.

From the viewpoint described above, more preferable range of b is from 0.0025 to 0.01 (0.125 to 0.5% by mole).

A preferable value of a+b+c in the before described average composition formula is determined from the viewpoint of achievement of a good rubber elasticity. If a+b+c=2, the value is most preferable since a base polymer is of a perfectly straight chain. Branching at some level is also allowed in ranges larger and smaller than the value of a+b+c=2 as far as an organopolysiloxane has a good rubber elasticity in the ranges. Accordingly, a+b+c is preferably in the range of from 1.98 to 2.02.

A viscoity at 25° C. of the before described organopolysiloxane is preferably 10,000 mPa·s or higher. This is because with an excessively low viscosity, mechanical strengths sometimes are insufficient. More preferable viscosities are in the range from 100,000 to 100,000,000 mPa·s. This is because with an excessively high viscosity, synthesis becomes harder or moldability is degraded. Most preferable viscosities are in the range of from 3,000,000 to 20,000,000 mPa·s and in a raw rubber state.

An organopolysiloxane expressed by the before described average composition formula can be obtained through ring opening polymerization of tri(trifluoropropyl)trimethylcyclotrisiloxane with a siloxane oligomer as in initiator expressed by the following chemical formula as described in, for example, Japanese Patent Application Laid-Open (JP-A) No.62-174260:

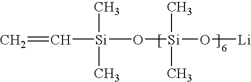

A silica-based filler as a component (B) is indispensable in order to obtain a silicon rubber compound excellent in mechanical strengths. For this purpose, a specific surface area is generally 50 m²/g or more and preferably in the range of from 100 to 400 m/g. Examples of silica-based fillers of the kind include fume: silica (dry silica), calcined silica, precipitated silica (wet silica).

Surfaces of the before described silica-based filler may be hydrophobicized with an organopolysiloxane, an organopolysilazane, a chlorosilane, a alkoxysilane or the like. These of silica may be employed alone or two or more kinds combined.

Note that if an additive amount of a silica filler of the component (B is less than 5 parts by weight relative to 100 parts by weight of an organopolysiloxane of the component (A), a sufficient reinforcement effect can not be obtained, while if exceeding 100 parts by weight, moldability is degraded and physical characteristics of obtained silicone rubber are lowered either. An additive amount of a silica filler of the component (B) is more preferably in the range of from 10 to 60 parts by weight.

A curing catalyst as a component (C) is a component to be added into a fluorosilicone rubber composition described above to cure the composition with the catalyst therein by a common method and thereby obtain a hardened material. Examples thereof include conventionally known curing catalyst, for example a combination of an organoperoxide, an organohydrogenpolysiloxane and a platinum catalyst; and the like. Among the before described examples, an organoperoxide is preferable.

Examples of organoperoxides include: benzoyl peroxide, tert-butyl parbenzoate, o-methylbenzoyl peroxide, p-methylbenzoy, peroxide, di(tert-butyl)peroxide, dicumyl peroxide, 1,1-bis(tert-butyl peroxy)3,3,5-trimethylcyclohexane, 2,5-dimethyl-2,5-di(tert-butyl peroxy)hexane, 2,5-dimethyl-2,5-di(tert-butyl peroxy)hexyne. The before described examples of organoperoxides may be either used alone or in combination of two or more kinds.

An additive amount of a curing catalyst can be catalyst quantity, for example, an additive amount of an organoperoxide is preferably in the range of from 0.1 to 5 parts by weight relative to 100 parts oy weight of an organopolysiloxane of a component (A).

A fluorosilicone rubber composition of the present invention used in a gasket rubber material can be properly added with a compounding chemical or the like commonly used in the field of gasket rubber materials as the dispensable components other than the components (A), (B) and (C), which are the indispensable components for the present invention, in a range in which said compounding chemical or the like does not hinder the effect of the present invention.

Examples of the before described compounding chemical or the like that can be added into a fluorosilicone rubber composition used in the present invention include, when required: non-reinforcing silica such as pulverized quartz, diatomaceous earth and the like; carbon black such as acetylene black, furnace black, channel black and the like; fillers such as calcium carbonate; additive agents such as a colorant, a heat resistance improving agent, a fire resistance improving agent, an acid receiving agent, a thermal conduction improving agent and the like; a releasing agent; dispersants such as alkoxysilane, diphenylsilanediol, a carbon functional silane, a low molecular siloxane having both ends coupled with silanol groups and the like.

A fluorosilicone rubber composition of the present invention used in a gasket rubber material can be obtained by mixing indispensable components (A), (B) and (C), and a dispersant etc. properly added thereto uniformly with a rubber kneader such as a two roll mill, a Banbury mixer, a dough mixer (kneader) or the like.

No specific limitation is imposed on a molding method for a fluorosilicone rubber composition in a way in which a fluorosilicone rubber composition obtained as described above is cured to obtain a gasket rubber material of the present invention. And a gasket can be molded in a desired shape by means of a method in conformity with a general rubber molding method such as a compression molding, transfer molding, injection molding, extrusion molding, calendering molding or the like. Though curing conditions can be properly adjusted, in this case, it is preferable that a heating temperature is in the range of from 160 to 250° C. and more preferably in the range of from 170 to 210° C., a duration is in the range of from 2 to 20 min and more preferably in the range of from 2 to 5 min. In addition, if necessary, a second curing treatment may be applied at a temperature in the range of from 180 to 250° C. for a time of the order in the range of 1 to 10 hr.

A gasket rubber product of the present invention thus obtained desirably has a volume change in a fuel oil resistance test (in Fuel C at 23° C. for 70 hr) of 50% or less. This is because if a volume change is 50% or larger, various defects such as slant, run-out, cracking may occur when a gasket made of a gasket rubber product of the present invention is used. Note that a volume change in the fuel oil resistance test (in Fuel C at 23° C. for 70 hr) is more desirably 25% or less from the viewpoint of occurrence of the inconveniences.

It is preferable that a compression set value at 150° C. for 72 hr of a cured product is 10% or less and a compression set value at 150° C. for 72 hr of the cured product in contact with a Nylon resin is 12% or less In a case where a gasket made of a rubber product with a compression set value of 13% or more is placed in a severe condition of an environmental temperature of 150° C. or higher, an interference of the gasket decreases and a seal life is shortened, which is unfavorable.

The present invention will be described more detaile with showing examples and comparative examples below.

### EXAMPLE 1

An organopolysiloxane A1 in a raw rubber state expressed by the following general formula was provided.

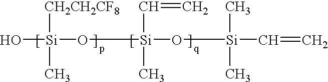

In this general formula, p and q are numbers with which an average degree of polymerization is 3000 and a content of a vinyl group is 0.15% by mole.

35 parts by weight of dry silica A2 (manufactured by Nippon Aerosil Co., Ltd. with a trade name of Aerosil 200) and 4 parts by weight of diphenylsilanediol as a dispersant were added to 100 parts by weight of an organopolysiloxane A1.

The components were kneaded into uniformity, the mixture was subjected to a heat treatment at 150° C. for 4 hr and thereafter the mixture was further ground to promote plasticization in a two roll mill to thereby obtain a compound A3.

0.8 part by wt of 2,5-dimethyl-2,5-di(tert-butyl peroxy) hexane was added 100 parts by weight of the compound A3, and then the components were kneaded by two roll mill. In such a way, there was obtained a fluorosilicone rubber composition A used in a working product of the present invention.

The fluorosilicone rubber composition A was press molded at 165° C. for 10 min. And then, it was post cured at 200° C. for 4 hr to thereby prepare a sheet of 2 mm in thickness for measurement of a physical properties. Also, the fluorosilicone rubber composition A was press molded at 170° C. for a min. And then, it was post cured at 200° C. for 4 hr to thereby prepare a test piece of 8.1 to 8.2 mm in thickness for compression set measurement.

### EXAMPLE 2

An organopolysiloxane A1 in a raw rubber state expressed by the following general formula was provided.

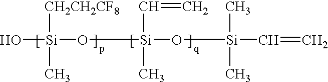

In this general formula, p and q are numbers with which an average degree of polymerization is 3000 and a content of a vinyl group is 0.15% by mole.

40 parts by weight of dry silica B2 (manufactured by Nippon Aerosil Co., Ltd. with a trade name of Aerosil 130) and 5 parts by weight of diphenylsilanediol as a dispersant were added to 100 parts by weight of an organopolysiloxane A1.

The components were kneaded into uniformity, the mixture was subjected to a heat treatment at 150° C. for 4 hr and thereafter the mixture gas further ground to promote plasticization in a two roll mill to thereby obtain a compound B3.

0.8 part by wt of 2,5-dimethyl-2,5-di(tert-butyl peroxy) hexane was added 100 parts by weight of the compound B3, and then the components were kneaded by two roll mill. In such a way, there was obtained-a fluorosilicone rubber composition B used in a working product of the present invention.

The fluorosilicone rubber composition B was used to obtain a sheet of 2 mm in thickness for physical property measurement and a test piece of 8.1 to 8.2 mm in thickness for compression set measurement in a similar way to that in the first example.

### COMPARATIVE EXAMPLE 1

An organopolysiloxane B1 in a raw rubber state expressed by the following general formula was provided.

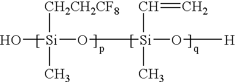

In this general formula, p and q are numbers with which an average degree of polymerization is 3000 and a content of a vinyl group is 0.075% by mole.

35 parts by weight of dry silica A2 (manufactured by Nippon Aerosil Co., Ltd. with a trade name of Aerosil 200) and 4 parts by weight of diphenylsilanediol as a dispersant were added to 100 parts by weight of an organopolysiloxane B1.

The components were kneaded into uniformity, the mixture was subjected to a heat treatment at 150° C. for 4 hr and thereafter the mixture was further ground to promote plasticization in a two roll mill to thereby obtain a compound C3.

0.8 part by wt of 2,5-dimethyl-2,5-di (tert-butyl peroxy) hexane was added 100 parts by weight of the compound C3, and then the components were kneaded by two roll mill. In such a way, there was obtained a fluorosilicone rubber composition C used in a comparative product.

The fluorosilicone rubber composition C was used to obtain a sheet of 2 mm in thickness for physical property measurement and a test piece of 8.1 to 8.2 mm in thickness for compression set measurement in a similar way to that in the first example.

### COMPARATIVE EXAMPLE 2

An organopolysiloxane B1 in a raw rubber state expressed by the following general formula was provided.

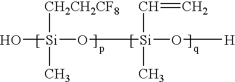

In this general formula, p and q are numbers with which an average degree of polymerization is 3000 and a content of a vinyl group is 0.075% by mole.

45 parts by weight of dry silica A2 (manufactured by Nippon Aerosil Co., Ltd. with a trade name of Aerosil 200) and 6 parts by weight of diphenylsilanediol as a dispersant were added to 100 parts by weight of an organopolysiloxane B1.

The components were kneaded into uniformity, the mixture was subjected to a heat treatment at 150° C. for 4 hr and thereafter the mixture was further ground to promote plasticization in a two roll mill to thereby obtain a compound D3.

0.8 past by wt of 2,5-dimethyl-2,5-di(tert-butyl peroxy) hexane was added 100 parts by weight of the compound D3, and then the components were kneaded by two roll mill. In such a way, there was obtained a fluorosilicone rubber composition D used in a comparative product.

The fluorosilicone rubber composition D was used to obtain a sheet of 2 mm in thickness for physical property measurement and a test piece of 8.1 to 8.2 mm in thickness for compression set measurement in a similar way to that in the first example.

### COMPARATIVE EXAMPLE 3

An organopolysiloxane B1 in a raw rubber state expressed by the following general formula was provided.

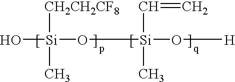

In this general formula, p and q are numbers with which an average degree of polymerization is 3000 and a content of a vinyl group is 0.75% by mole.

35 parts by weight of dry silica A2 (manufactured by Nippon Aerosil Co., Ltd. with a trade name of Aerosil 200), 10 parts by weight of amorphous silica (manufactured by Tatsumori Ltd. with a trade name of Imsil A10) and 5 parts by weight of diphenylsilanediol as a dispersant were added to 100 parts by weight of an organopolysiloxane B1.

The components were kneaded into uniformity, the mixture was subjected to a heat treatment at 150° C. for 4 hr and thereafter the mixture was further ground to promote plasticization in a two roll mill to thereby obtain a compound E3.

0.8 part by wt of 2,5-dimethyl-2,5-di(tert-butyl peroxy) hexane was added 100 parts by weight of the compound E3, and then the components were kneaded by two roll mill. In such a way, there was obtained a fluorosilicone rubber composition E used in a comparative product.

The fluorosilicone rubber composition E was used to obtain a sheet of 2 mm in thickness for physical property measurement and a test piece of 8.1 to 8.2 mm in thickness for compression set measurement in a similar way to that in the first example.

### TEST RESULTS

The test pieces from the examples 1 and 2, and the comparative Examples 1 to 3 were used to conduct tests for initial physical properties and compression set according to the following methods. Results are shown in Table 1.

TABLE 1

| Composition (parts by | | Example | Comparative | Comparative | Comparative |
|---|---|---|---|---|---|
| weight) | Example 1 | 2 | example 1 | example 2 | example 3 |
| Organopolysiloxane A | 100 | 100 | | | |
| Organopolysiloxane B | | | 100 | 100 | 100 |
| dry silica A | 35 | | 35 | 45 | 35 |
| dry silica B | | 40 | | | |
| Amorphous silica | | | | | 10 |
| Diphenylsilanediol | 4 | 5 | 4 | 6 | 5 |
| Initial physical properties | | | | | |
| Hardness (duro-meter A) | 65 | 72 | 69 | 75 | 73 |
| Tensile strength (MPa) | 9.3 | 9.4 | 9.2 | 9.2 | 8.8 |
| Tensile elongation at break | 220 | 190 | 260 | 220 | 260 |
| (%) | | | | | |
| Fuel oil resistance volume | +21 | +21 | +23 | +23 | +22 |
| change (%) in Fuel C at | | | | | |
| 23° C. × 70 hr | | | | | |
| Compression set at 180° C. × | 7 | 5 | 10 | 9 | 10 |
| 22 hr (%) | | | | | |
| Compression set (in contact) | 6.3 | 4.9 | 7.7 | 6.7 | 10.2 |
| with SUS) at 150° C. × 72 hr | | | | | |
| (%) | | | | | |
| Compression set (in contact | 9.3 | 7.8 | 16.6 | 15.9 | 19.4 |
| with Nylon) at 150° C. × 72 hr | | | | | |
| (%) | | | | | |

### TEST METHOD

### Initial Physical Properties: in Conformity with JIS K6249

Compression Set: A test piece with a thickness of from 8.1 to 8.2 mm was placed on a 6Nylon resin with a thickness of 3.2 mm and a compression set value was measured in conditions at 150° C. for 72 hr pressed at a compressibility of 25%. Furthermore, with a SUS plate with the same thickness of 3.2 mm instead of the 6 Nylon resin, a compression set value was measured at the same time when a compression set value was measured with respect to the test piece placed on a 6 Nylon resin.

It was recognized from the results of Table 1 that the gasket rubber products of the present invention made of cured materials of fluorosilicone rubber compositions each containing indispensable components (A), (B) and (C) described above were low in compression set value and small in change over time, especially, even in a case where a test piece is in contact with a 6 Nylon resin, which are useful for a gasket for a resin intake manifold.

While description has been given of the preferred embodiments of the present invention, it should be understood that the present invention is not limited to the examples and various alterations or modifications thereof can be implemented without departing from the technical scope determined by the terms of the appended claims.

1. A gasket rubber product made of a cured material of a fluorosilicone rubber composition containing:
100 parts by weight of an organopolysiloxane expressed by the following average composition formula:
R¹ₐR²_{b}R³_{c}SiO_{(4-a-b-c)/2}
wherein R¹ indicates a trifluoropropyl group, R² indicates a non-substituted or substituted monovalent aliphatic unsaturated hydrocarbon group having 2 to 8 carbon atoms, R³ indicates a non-substituted monovalent aliphatic saturated hydrocarbon group or aromatic hydrocarbon group having 1 to 8 carbon atoms, provided that a, b and c are positive numbers satisfying 0.96≦a≦1.01, 0.002≦0.02, 0.96≦c≦1.06 and 1.98≦a+b+c≦2.02;
5 to 100 parts by weight of a silica-based filler; and
a catalyst quantity of a curing catalyst:

2. A gasket rubber product according to claim 1, used in contact with a resin.

3. A gasket rubber product according to claim 2, wherein the resin is Nylon.

4. A gasket rubber product according to claim 1, wherein the compression set value at 150° C. for 72 hr of a cured product of the fluorosilicone rubber composition is 10% or less and the compression set value at 150° C. for 72 hr of the cured product in contact with a 6 Nylon resin is 12% or less.

5. A gasket rubber product according to claim 1, used as a resin intake manifold gasket.
